(19) United States
(12) Patent Application Publication
(10) Pub. No.: US 2004/0177913 A1
(43) Pub. Date: Sep. 16, 2004

(54) Method of fabricating an air gap between optical devices

(76) Inventors: Sean Chang, Taoyuan City (TW); Shih-Shiun Chang, Chishan Jen (TW)

Correspondence Address: PRO-TECHTOR INTERNATIONAL, 20775 Norada Court, Saratoga, CA, 95070-3018, US

(21) Appl. No.: 10/615,631

(22) Filed: Jul. 8, 2003

(30) Foreign Application Priority Data
Mar. 13, 2003 (TW) 92105553

(51) Int. Cl. B32B 31/00

(52) U.S. Cl. 156/74; 156/99; 156/292

(57) ABSTRACT

A method of fabricating an air gap between optical devices includes the following steps. Two optical devices are prepared. At least two spacers are formed on each of two opposite edges of a surface of one of the two optical devices. The at least two spacers on each of two opposite edges separate from one another with a predetermined interval. An adhesive is applied onto the predetermined interval between the at least two spacers on each of two opposite edges. The two optical devices are adhered by means of the adhesive. Finally, the adhesive is cured.

### BACKGROUND OF THE INVENTION

1. Field of the Invention

The invention relates to a method of fabricating an air gap between optical devices, and more particularly, to a method of fabricating an air gap between optical devices suitable for using in optical projection equipments, such as a set of optical devices for refracting light or performing color separation for light in order to facilitate the application of other optical devices.

2. Description of the Related Art

The common process for fabricating an air gap between optical devices is to apply an adhesive to an object with a fixed height or thickness (such as optical fiber) or use an adhesive for bonding deposited layers to form spacers. And an air gap with a fixed distance between two optical devices can be formed. Consequently, an optical device set with a fixed gap can be fabricated.

Specifically, a pertinent technique is disclosed in U.S. Pat. No. 4,948,228, which employs an air gap to separate two prisms. The prior art utilizes the different refractive indexes between two prisms and air to generate a total reflection effect for rotating images. In addition, a total reflection effect applied to endoscopes is disclosed in U.S. Pat. No. 4,138,192, wherein the space between two prisms is coated with a transparent adhesive such that a total reflection effect is generated by the refractive index difference between two prisms and the transparent adhesive. Moreover, a total reflection effect for improving the visual field of endoscopes as well as diminishing volume of endoscopes is disclosed in U.S. Pat. No. 4,783,156. In this prior art, prisms deposited with a plurality of layers are glued together by adhesive, and the refractive index difference between prisms and the plurality of deposited layers is used to generate a total reflection effect that can be utilized in endoscopes.

To illustrate the assembling method of optical devices, an adhesive 14 such as epoxy resin is applied to the two opposite edges of the surface on the connecting face of one of the optical devices 11, as shown in FIG. 1A. When assembling, not only can the adhesive 14 adhere two optical devices, but the adhesive 14 can also serve as a spacer of two optical devices to form an air gap. On the other hand, as shown in FIG. 1B, the physical vapor deposition (PVD) can alternately be employed, which is to form deposition on the two opposite edges of the surface of one of the optical devices 11 so that a deposited layer 15 can be formed and used as a consecutive spacer. Next, when assembling, the adhesive 14 is spread on the deposited layer 15 in order to adhere optical devices 11 together with the deposited layer 15 therebetween as the spacer. The adhesive 14 that is spread on the spacer can be spread out evenly by applying gentle force on it. Therefore, an optical device set with certain air gap space is formed.

However, two main drawbacks may be encountered when employing the aforementioned method of assembling optical devices. One of the drawbacks is that when the adhesive 14 is coated on the two opposite edges of the surface of the optical devices or on the spacers for adhesive bonding, the width and uniformity of air gap space between the optical devices cannot be controlled precisely because the adhesive 14 is a gluey material and, therefore, the air gap space will be influenced by the thickness and smoothness of adhesive 14 that is spread on the surface of optical devices or spacers. The other drawback is that when another optical device is adhered to the optical device 11, the employed pressing step for adhesion is often accompanied by adhesive overflow because the spread-out quantity and smoothness of the adhesive 14 is hard to be controlled or the force applied for pressing can be unbalanced. As a result, not only is the spread of adhesive 14 unable to be smooth, but the width and uniformity of air gap space can also be seriously affected. Besides, the optical devices may be contaminated due to glue overflow, or the adhesive 14 may block light path 21 and therefore decrease the quality of light path, which in turn may lower the overall performance of optical devices.

Therefore, it is an important issue to precisely control width and uniformity of air gap space between optical devices so as to prevent undesired or uneven adhesive thickness as well as to increase the effectiveness of light application, so that the light path will not be contaminated or blocked by the adhesive, and the effect of overall optical device utilization can be enhanced.

### SUMMARY OF THE INVENTION

To solve the aforementioned problems, the object of the invention is to provide a method of fabricating an air gap between optical devices so that the width of air gap space between optical devices can be precisely controlled to achieve space uniformity and avoid being influenced by the undesired or uneven adhesive thickness. Besides, the prior problem of light path contamination due to adhesive overflow and uneven spread of adhesive can be improved so that light utilization can be enhanced and the overall performance of optical devices can be enhanced as well.

Therefore, to achieve the aforementioned object, the method of fabricating air gap between optical devices includes the following steps. Two optical devices are prepared. At least two spacers are formed on each of two opposite edges of a surface of one of the two optical devices. The at least two spacers on each of two opposite edges separate from one another with a predetermined interval. An adhesive is applied onto the predetermined interval between the at least two spacers on each of two opposite edges. The two optical devices are adhered by means of the adhesive. Finally, the adhesive is cured.

Through the method of fabricating air gap between optical devices according to the present invention, the width of air gap space can be kept constant, and the adhesive can be prevented from overflowing into the light path and contaminating the path. Hence, the efficiency and intensity of light as well as the purity of light path can be ensured because the light path will not be contaminated. Thus, the overall performance of optical devices can be enhanced.

### BRIEF DESCRIPTION OF THE DRAWINGS

FIGS. 1A and 1B are schematic diagrams showing two conventional methods of fabricating an air gap between optical devices.

FIG. 2 is a schematic diagram showing an optical device provided with spacers separating by a predetermined interval, which is placed on a centrifugal device for spreading an adhesive, according to the present invention.

FIG. 3 is a schematic diagram showing adhering of two optical devices according to the present invention.

FIG. 4 is a schematic side view of an optical device set according to the present invention.

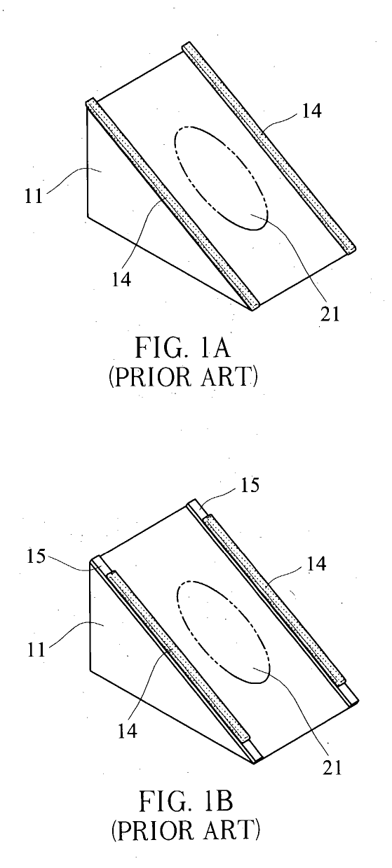

### DETAILED DESCRIPTION OF THE PREFERRED EMBODIMENTS

The method of fabricating an air gap between optical devices according to the embodiment of the present invention will be described below with reference to the drawings, wherein the similar components will be denoted by the same reference numerals.

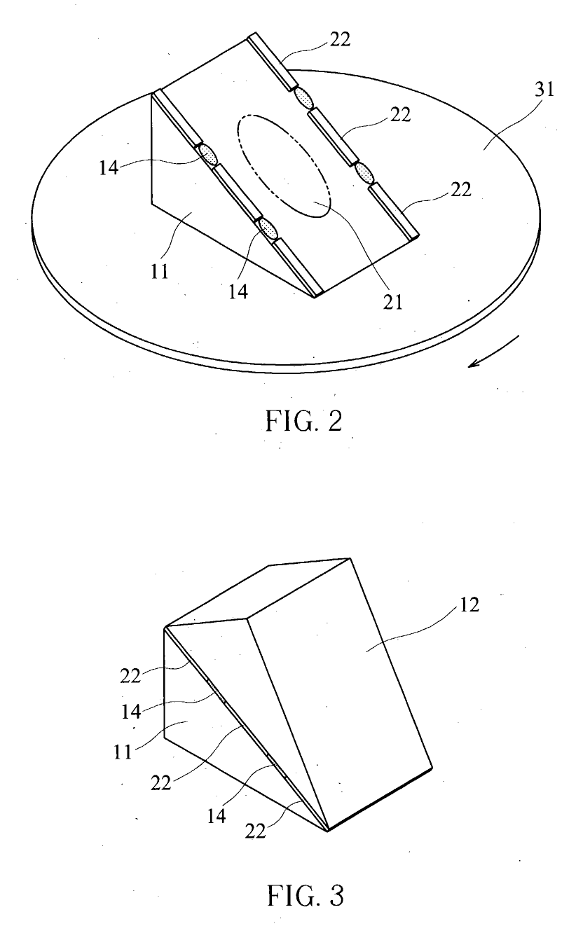

FIGS. 2 to 4 are schematic diagrams showing a method of fabricating an air gap between optical devices according to the present invention.

In the embodiment, as shown in FIGS. 2 and 3, two optical devices 11 and 12 are prepared first, and then PVD is employed so that at least two spacers 22 are formed on each of two opposite edges of a surface of one of the optical devices 11 and 12. As to the material for spacers, any materials suitable to be formed by PVD may be taken, and in general, the material can be a metal coating film or dielectric coating film. In addition, each of the spacers 22 on each of two opposite edges can be separated from one another with a predetermined interval. Then, the adhesive 14 is applied onto the predetermined interval between each of the two spacers 22. With the arrangement of the adhesive 14, the optical device 12 is adhered to the optical device 11, as shown in FIG. 3. Finally, the adhesive 14 is cured to complete an optical device set according to the present invention.

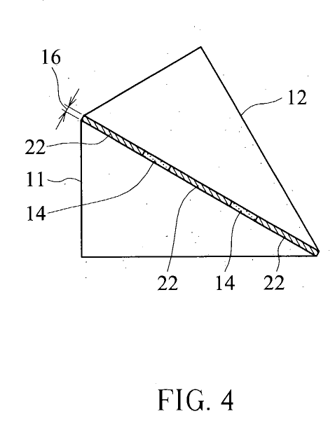

In particular, the thickness of the spacers 22 between the optical devices 11 and 12 is equal to the width of air gap space 16 shown in FIG. 4. Furthermore, referring again to FIG. 2, a centrifugal device is employed after applying the adhesive 14 onto the predetermined interval between the spacers 22. As for employing the centrifugal device, the optical devices 11 and 12 coated with the adhesive 14 may be placed on the centrifugal rotary disk 31. Through the centrifugal force generated by the rotations made by the centrifugal rotary disk 31, an undesired, excessive portion of the adhesive 14 can be made overflowed out of the optical devices 11 and 12 so that the adhesive 14 can evenly fill up the predetermined interval between the spacers 22. Therefore, the coated adhesive thickness can be ensured to be even, and meanwhile, adhesive overflow generated at bonding can be avoided so that the purity of light path 21 can be maintained.

In conclusion, as shown in FIG. 4, by employing the method of fabricating an air gap between optical devices according to the present invention, the prior art problem of unequal air gap space caused by uneven adhesive thickness or uneven adhesive coating can be resolved. Hence, the uniformed air gap space 16 can be achieved and the purity of light path can also be ensured.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A method of fabricating an air gap between optical devices comprising:
preparing two optical devices;
forming at least two spacers on each of two opposite edges of a surface of one of the two optical devices, wherein the at least two spacers on each of two opposite edges separate from one another with a predetermined interval;
applying an adhesive onto the predetermined interval between the at least two spacers on each of two opposite edges;
adhering the two optical devices by means of the adhesive; and
curing the adhesive.

2. The method according to claim 1, wherein the at least two spacers on each of two opposite edges are formed by means of physical vapor deposition (PVD).

3. The method according to claim 1, wherein the at least two spacers on each of two opposite edges are made of a metal coating film.

4. The method according to claim 1, wherein the at least two spacers on each of two opposite edges are made of a dielectric coating film.

5. The method according to claim 1, further comprising a step of:
applying a centrifugal force to spread out the adhesive after the step of applying an adhesive onto the predetermined interval between the at least two spacers on each of two opposite edges.

6. The method according to claim 5, wherein the step of applying a centrifugal force is performed by a centrifugal rotary disk.
